(19) United States
(12) Patent Application Publication
(10) Pub. No.: US 2015/0294293 A1
(43) Pub. Date: Oct. 15, 2015

(54) MOBILE PAYMENT METHOD AND A SYSTEM THEREFORE

(71) Applicant: Seamless Distribution AB, Stockholm (SE)

(72) Inventor: Mikael Signarsson, Upplands Vasby (SE)

(21) Appl. No.: 14/376,487

(22) PCT Filed: Jan. 15, 2013
(86) PCT No.: PCT/SE2013/000006

§ 371 Date: Aug. 4, 2014

Related U.S. Application Data
(60) Provisional application No. 61/595,843, filed on Feb. 7, 2012.

(30) Foreign Application Priority Data
Feb. 3, 2012 (SE) 1200074-1

(51) Int. Cl. G06Q 20/32; G06Q 20/10; G06Q 20/40; G06Q 20/20

(52) U.S. Cl. CPC G06Q 20/322; G06Q 20/204; G06Q 20/102; G06Q 20/40; G06Q 20/327

(57) ABSTRACT

The invention relates to a method and a system adapted to the payment of goods through a retailer point of sale terminal (22) utilizing a cellular device (16) to close a purchase at the retailer, the terminal (22) comprising card reader (24, 26) abilities. Moreover, the terminal (22) site is equipped with a code tag (30), and assigned a swipe card (28) with the same code as the tag (30). A customer reads (42) the tag (30) with the cellular device (16), and a terminal clerk swipes the card on the terminal (22), and the read (42) tag (30) code and the card code are matched in a settlement switch (34) to close a purchase.

### TECHNICAL FIELD

The present invention pertains to a method and a system adapted to the payment of goods through a retailer point of sale terminal utilizing a cellular device to close a purchase at the retailer, the terminal comprising card reader abilities.

### BACKGROUND ART

A conventional credit card payment at a point of sale (POS) is performed at a merchant/retailer existing POS connected to a credit card processing payment service provider (PSP) platform to process credit card payments. The backend/backbone PSP platform is connected to the POS terminal. Payment PSP's networks such as Visa®, MasterCard®, and others utilize a payment processing system run through the backend platform to settle payments made by an end user/costumer provided with a card issued by a Card Issuer, which is swiped or put in to a slot if it is a smart card, and read by the POS terminal when the end user makes a purchase at a retailer.

The cards issued by known Card Issuer's (banks or financial institutions) are connected to a PSP, which settles the accounts between the end user and the retailer through the Issuer Identification Number, an identity issuer code of the card to direct the payment to the correct PSP and Card Issuer through a settlement switch.

A PSP issuer code is characterized by a prefix, the first digits of a debit/credit card as for instance Visa® could be identified by the six digit and dial up prefix [4539 03], issuer identification number (IIN), and MasterCard® by the digits [5412 56].

The backend platform system can utilize the known Electronic Data Interchange (EDI) message system for payment settlements. EDI is a direct communication between computer systems, utilizing telecommunication networks. EDI messages are as basic as orders and invoices, but may be more complex information exchanges for payment settlements.

Another known message system for payments is the Electronic Funds Transfer (EFT), which allows electronic exchange or transfer of money from one account to another, either within a single financial institution or across multiple institutions, through computer-based systems.

### SUMMARY OF THE INVENTION

One aim among others of the present invention is to introduce a payment method and a system therefore to enable payments through a mobile device/cellular device such as those that can transfer cellular radio data for instance a mobile phone/cellular phone and its likes through a point of sale (POS) without introducing any changes to the electronic POS terminal itself, either by software, hardware, or firmware. A limited effort is required in the list of card prefixes, whitelist, but it can be run remotely by the POS via the switch terminal it is connected to. Furthermore, if the card is a pseudo card provisioned as software in the POS terminal, and a mobile payment is to be accomplished through a pseudo card, the POS terminal software is copied, and the steps where the card has to be swiped or inserted in the POS is removed. Thereafter, the slightly changed software is restored into the POS terminal.

Hence, the present invention sets forth a method adapted to the payment of goods through a retailer point of sale terminal utilizing a cellular device to close a purchase at the retailer, the terminal comprising card reader abilities. The invention provides the terminal with a terminal card, having a unique card code belonging to the terminal and retailer, where the card code issuer (PSP) provides the card with its unique issuer code differing from current issuer card codes, the terminal being utilized by the terminal (22) operating clerk to enable a reading of the terminal card data when a customer is closing a purchase;

transmitting the card data through a transaction switch/acquirer switch/POS switch), which recognizes the unique issuer code, and sends the card data to a payment settlement switch through an existing terminal back end network when utilized by the clerk to identify the retailer and the unique terminal;

providing the terminal with a terminal code tag, which is unique to the terminal and the code of the terminal card, to be read by a customer utilizing the cellular device to register the code in the cellular device, through a payment application stored in the cellular device, and means attached to the cellular device, when closing a purchase, the cellular device upon agreement by the customer, through the cellular device, transmitting the read unique terminal code through a cellular network related to the cellular device, to the settlement switch;

matching the unique card code with the terminal code, and closing the purchase when there is at least partly a match between the two codes transmitted, by sending a clearance note to the point of sale terminal through the back end network, thus enabling a utilization of an existing point of sale terminal without any major alterations made to the terminal; and

the switch settling the purchase with accounts belonging to the retailer and customer, respectively.

In one embodiment of the present invention provides that the payment settlement switch is transmitting all details about a purchase to a customer's cellular device as a receipt, initiated by the switch to a customer's cellular device.

Another embodiment provides that the code tag is of the type quick response (QR), 2D code, barcode, RFID or NFC code or similar, or a character code visible to the naked eye, i.e. a numerical or alphanumerical code.

A further embodiment provides that the reading is accomplished by a scanner or a camera comprised in the cellular device.

A still further embodiment provides that the card is a pseudo card provisioned as software in the POS terminal. Furthermore, the present invention sets forth a system adapted to the payment of goods through a retailer point of sale terminal site utilizing a cellular device to close a purchase at the retailer, the terminal comprising at least one card reader slot. The system comprises:

a back end network connected to the terminal at its site, a terminal card, having a unique card code belonging to the terminal and retailer, where the card code issuer (PSP) provides the card with its unique issuer code differing from current issuer card codes, the terminal being utilized by the terminal operating clerk to enable a reading of the terminal card data when a customer is closing a purchase;

a transaction switch, which recognizes the unique issuer code, and sends the card data to;

a payment settlement switch through the existing terminal back end network when utilized by the clerk to identify the retailer and the unique terminal transmitting the card data;

a payment application stored in the cellular device adapted to read a tag at the terminal site through reading means attached to the cellular device, and to trigger a communication to the settlement switch;

a terminal code tag placed at the terminal site, which is unique to the terminal and matching the code of the terminal card, to be read by a customer utilizing the cellular device to register the code in the cellular device through the reading means, the cellular device upon agreement by the customer, through the cellular device, transmitting the read unique terminal code through a cellular network related to the cellular device, to the settlement switch when closing a purchase; and

a matching means adapted to match the unique card code with the terminal code, and closing the purchase when there is a match between the two codes transmitted, by sending a clearance note to the point of sale terminal through the back end network, thus enabling a utilization of an existing point of sale terminal without any alterations made to the terminal; the switch settling the purchase with accounts belonging to the retailer and customer, respectively.

One embodiment of the present invention comprises a payment settlement switch, which transmits all details about a purchase to a customer's cellular device as a receipt, initiated by the switch to a customer's cellular device.

A further embodiment comprises that the code tag is of the type quick response (QR), 2D code, barcode, RFID code, NFC code or any other similar contact less method, or a character code visible to the naked eye.

Yet another embodiment comprises that the reading means is a scanner or a camera comprised in the cellular device.

Yet still another embodiment comprises that the card is a pseudo card provisioned as software in the POS terminal.

### A BRIEF DESCRIPTION OF THE DRAWING

Henceforth, reference is had to the accompanying drawing throughout the present description for a better understanding of the present inventions embodiments, and given examples, wherein:

FIG. 1 schematically illustrates a system for purchasing at a POS with a cellular device in accordance with the present invention.

### DETAILED DESCRIPTION OF PREFERRED EMBODIMENTS

The present invention regards a method and a system to perform a mobile payment transaction at an already existing credit card payment terminal at a merchant/retailer, which does not require any additional equipment investment or development/customization of the existing software, hardware, or firmware at a POS.

According to the present invention, one embodiment comprises that an end user having a mobile device/cellular device enabled through software to perform mobile payments through an existing mobile payment system. In accordance with the present invention a card, swipe card and/or smart card, or a pseudo card provisioned as software in the POS terminal, is issued to a merchant's/retailers POS. When a mobile payment is to be accomplished through a pseudo card, the POS terminal software is copied, and the steps where the card has to be swiped or inserted in the POS is removed. Thereafter, the slightly changed software is restored into the POS terminal.

This card uniquely identifies one specific POS terminal at the retailer through the card numbers and/or the digits of the card memory area for instance magstrip or computer chip, which is issued by a payment settlement company, having a unique payment service provider (PSP) release identity as an example for instance IIN 9999 99-- ---- ---- with digits [----] for instance identifying the retailer, the unique POS terminal and other relevant banking data, i.e. the card is similar to known PSP card issuers, but differing in the issuer identity, IIN, in this example through the digits [9999 99]. This automatically integrates the POS with existing EDI message systems, and requires no alteration of the POS terminal itself. The only requirement on the POS terminal is to configure it to the example issuer identity [9999 99], i.e. so that it knows the identity, which is a simple matter to accomplish.

Furthermore, the site of the POS is tagged with a unique code identifying the POS in question for a purchase made contactless by an end user through a cellular device, having a card in accordance with the present invention.

A method of the present invention to conduct a purchase at a retailer is as follows in one exemplifying embodiment. The retailer enters the amount to be paid by the end user into the POS terminal. Thereafter, the retailer swipes the card that is issued to this specific POS in the POS slot or puts it into a slot to read the card by the on card computer chip if it is a smart card. This triggers the terminal to debit the specific amount to a mobile payment processing platform to a settlement switch, without knowing the credentials of the end user. The terminal is on hold for authorization and payment verification.

In one embodiment the processing will time out after for instance 30 seconds if no response is received by the POS, or if cancelled by the POS terminal clerk. At the same time, earlier or after the card has been swiped, read, or triggered by software, the end user scans/reads a code from a sticker/tag/label/radio frequency communication (RFID), or similar near field communication (NFC), with which the POS is tagged through software in his cellular device or enters a code of the specific shop that reveals the identity of the retailer shop, whereby the code is sent to the settlement switch through the cellular network in use. This will allow the POS terminal to request information about any outstanding payments for the specific point of sale and further matching the POS payment request with the end users cellular device transmitted code to accomplish payment in the settlement switch. Hence, the payment request from the POS and the request to pay the amount entered into the POS terminal can now be matched in the settlement switch by utilizing the unique POS identity.

Once the match has been accomplished, the end user receives a bill to be paid comprising the recipient name, i.e. the retailer shop, and the amount to be paid. Still the shop retailer is not aware of the end user identification while waiting for payment verification, and the end user can still choose to approve or deny the payment transaction. If the end user chooses to approve the payment he/she will be requested to enter a personal identity code (PIN) to approve the payment, whereby the payment is processed and the relevant amount of payment will be charged to the end user. Upon payment has been accomplished, the POS is notified through the settlement switch that the payment has been processed and a print out of a receipt with the payment details is conducted. But, still the identity of the end user is unrevealed.

In order to affiliate the present invention to a POS terminal it is assumed that the retailer has a POS terminal issued by a 3rd party that is connected and provisioned in a payment settlement switch. As well as a mobile payment application or service has been provisioned to the end user cellular device in beforehand. It is appreciated that the payment transaction system in accordance with the present invention can be utilized to process any means of payment, i.e. charge the total amount to be paid in a purchase to a credit card, bank account. Moreover, any other means of payment such as a lunch coupon or other type of coupons, gift cards and the like can be processed by the POS terminal as is currently possible.

The present invention solves many important problems known when implementing currently known cellular device payment solutions at POS terminals. For example, no sensitive payment credentials are used by the end user at the POS terminal. User payment credentials remain unrevealed or anonymous minimizing the possibility of fraud or skimming at the site of the POS terminal. Also, no significant new software is required to be installed at a POS terminal situated at a retailer shop, only a sticker/NFC tag, or code. If that would be the case it would require huge investment costs at current POS terminals. Furthermore, no changes to the electronic payment flow or processes are implemented to known existing POS payment terminals and its backend network. Hence, the POS terminal payment by an end user remains identical to a traditional payment except that the swipe of a retailer card unique for the POS in use is accomplished instead of the utilization of an end user owned card such as current PSP released cards like Visa®, MasterCard® or the like.

An end user identifies himself with a mobile payment application using the camera or scanner or by entering a unique payment code for the merchant, and the specific POS terminal. The present invention payment innovation can further process multiple means of payments using the same technology as described herein. Since the invention does not require any amendments made to the POS terminal, all existing reports, reconciliations etc. work fully transparent as with currently existing POS terminals.

A mobile payment by the cellular device can be performed at a POS terminal, without the POS knowing the identity of the cellular device by instead requesting a payment of a total amount through a specific transaction identification, instead of routing the transaction to perform a specific customers payment instrument and revealing the identity of the end user or his payment account. The POS simply sends a single request to a payment process requesting an amount to be paid in accordance with the present invention.

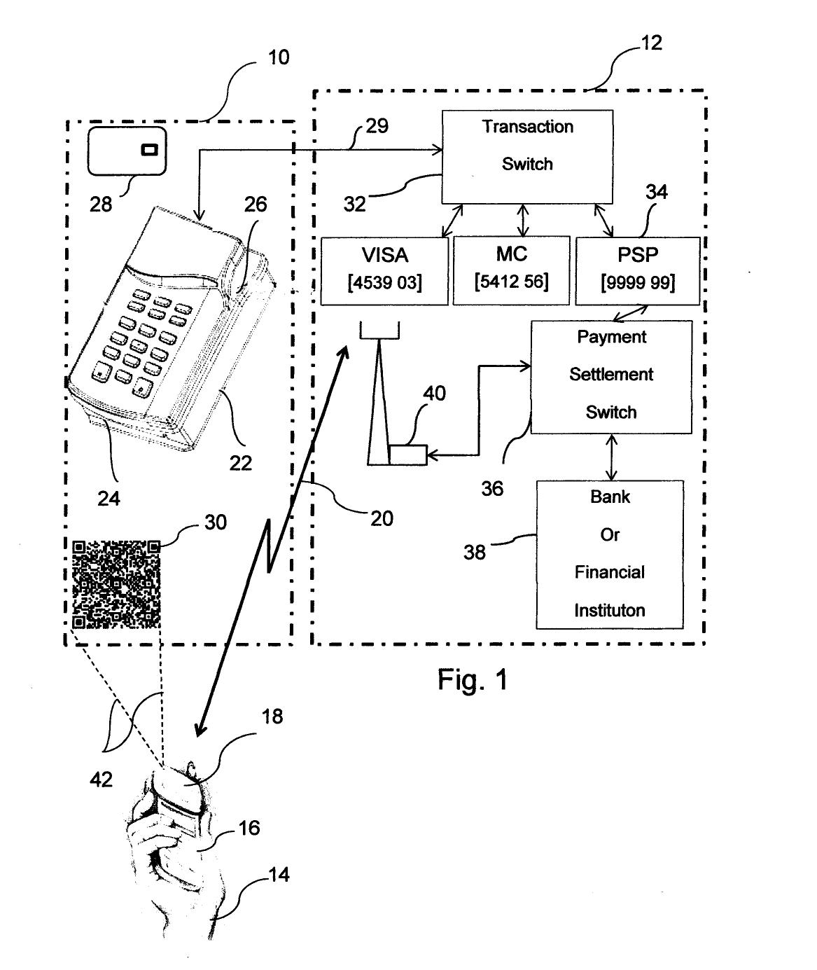

Henceforth, the present invention is described by referring to the attached FIG. 1.

FIG. 1 illustrates the system of the present invention utilized to perform the method of the present invention, whereby a POS terminal site 10 at a retailer shop is depicted with broken and dotted lines, and a back net/backbone net 12 is schematically depicted. The POS terminal site and the back net 12 are communicating electronically as depicted by double arrows in FIG. 1. A purchaser/end user hand 14 holding a cellular phone 16 with a display screen 18 is depicted as the actual closing of a purchase of bought goods is performed by utilizing the device 16 in accordance with the present invention. A wireless communication between the device 16 and a cellular network is schematically shown as a flash symbol 20. It is appreciated that a mobile device/cellular device 16 can be of any type. capable of cellular radio communication such as a conventional cellular phone, Iphone®, Ipad®, personal digital assistant (PDA) or the like, no matter if the communication is established through 2G, 2,5G, 3G, or a 4G cellular network. It is also appreciated that a retailer, in the gist of the present invention, could be a merchant or any company, store, shop, or business selling any kind of goods or provided services that are paid through a POS terminal 22. The POS terminal shown in FIG. 1 is just one example out of many such as cash register devices with card reading abilities, and thus the present invention is not limited to the type shown in FIG. 1.

The POS terminal 22 is equipped with a slot 24 for reading PSP issued smart cards which are equipped with an on card computer chip, and a slot 26 for swiping of PSP issued cards. This is not intended to exclude POS terminals 22, which only have a smart card slot 24, or a swipe slot 26, as a smart card can be utilized on either of such POS terminals 22. As mentioned the card can be a pseudo card provisioned in the POS terminal 22. In the following description a card is utilized to describe the present invention, but the invention is not limited to physical card 28 as such. It can be a pseudo card in one embodiment.

A PSP has provided the retailer a card 28 that uniquely identifies the specific POS terminal 22 when swiped by a POS clerk during a purchase with an end user, thus sending at least the amount the POS terminal, and retailer identity to the backend net 12. The PSP that provides the retailer with the card 28 has his own card issuer identity four digits/dial up prefix such as for instance 9999 ---- ----- ----, comprising for instance the specific POS identity, and/or also provided on the card magstrip and/or computer chip. It should be noticed that a retailer with several POS terminals 22 receives a unique PSP issued card 28 for every terminal 22, which identifies only the terminal 22 for which it is issued. Currently known physical card reading functions in existing POS terminals 22 can all be utilized by the present invention.

Schematically depicted in FIG. 1 by a double arrow 29 is the communication between the POS terminal site 10 and the back end net 12. It is appreciated that this communication could be performed wireless through a cellular network, not shown in FIG. 1, Internet, and through PSTN dial-up or any other similar or relevant communication method.

When an end user scans/reads/takes a picture of the tag 30, schematically indicated by the broken lines 42 in FIG. 1, while purchasing, the tag includes at least the identity of the POS terminal 22, and the retailer, whereby the end user is able to confirm his purchase by entering a PIN code associated to the mobile application that records the tag 30 in the cellular device 16 in use, and the tag 30 information with the POS identity is transmitted to the back end net 12 for settlement of the purchase and its closing.

As an example, the card 28 comprises the POS terminal 22 identity and the retailers identity for instance the code [zzzz 01]. The same or an associated code [zzzz 01] is provided on the tag 30. Hereby, the identity transmitted by the POS terminal 22 [zzzz 01] is matched with the identity [zzzz 01] transmitted by the cellular device 16 through the scanned or read tag 30. Hence, if those two identities match at least partly in one embodiment, the purchase is permitted and closed. Of course, the end user account is also checked for the account balance so that it is not overdrawn to be able to pay the amount that was transmitted from the POS terminal 22 before the purchase is closed.

The tag 30 can be of several types such as a quick response code (QP) 30, all kind of 2D codes, barcodes and/or RFID, NFC tags and/or character code visible for the naked eye or the like. If it is a character code visible to the naked eye, it could in one embodiment of the invention be entered into the cellular device 16 through its key pad, or read/scanned/by footage 42 as the other codes.

Furthermore, the FIG. 1, as mentioned, schematically depicts a back end/backbone network for settlement of payments from POS terminals 22. Hereby, a transaction/payment switch 32 receives the information transmitted from the POS terminal 22, and specifically checks the four code card issuer digits, in this example PSP (34) code [9999 99], and recognizes that this card is issued by PSP 34, which directs the purchase information message to a payment and settlement switch 36, where the match between the two identical codes [zzzz 01] is accomplished, closing the purchase, and settling it with a bank, financial institution 36 or the like. The financial institution 36 communicates with the POS 22 through a standard integration interface. If for instance as currently a Visa® card is swiped, the switch 32 directs it to the Visa® settlement system (not shown in FIG. 1).

Also schematically depicted is the communication 20 through a cellular networks base station 40 with an antenna, made by the end user cellular device 16, to accomplish the purchase match.

The attached set of claims determines other possible embodiments of the present invention to a person skilled in the art of the present technical field.

1. A method adapted to the payment of goods through a retailer point of sale Terminal utilizing a cellular device to close a purchase at the retailer, said terminal comprising card reader abilities, said method comprising:
providing said terminal with a terminal card, having a unique card code belonging to said terminal and retailer, where the card code issuer (PSP) provides the card with its unique issuer code differing from current issuer card codes, said terminal being utilized by the terminal operating clerk to enable a reading of the terminal card data when a customer is closing a purchase;
transmitting said card data through a transaction/payment switch, which recognizes said unique issuer code, and sends said card data to a payment settlement switch through an existing terminal back end network when utilized by said clerk to identify the retailer and the unique terminal;
providing said terminal with a terminal code tag, which is unique to the terminal and matching at least a part of the code of the terminal card, to be read by a customer utilizing said cellular device to register said code in the cellular device, through a payment application stored in said cellular device, and means attached to the cellular device, when closing a purchase, said cellular device upon agreement by the customer, through the cellular device, transmitting the read unique terminal code through a cellular network related to the cellular device, to said settlement switch;
matching the unique card code with said terminal code, and closing the purchase when there is at least partly a match between the two codes transmitted, by sending a clearance note to said point of sale terminal through said back end network, thus enabling a utilization of an existing point of sale terminal; and said switch settling the purchase with accounts belonging to the retailer and customer, respectively.

2. A method according to claim 1 , wherein said payment settlement switch is transmitting all details about a purchase to a customer's cellular device as a receipt, initiated by said switch to a customer's cellular device.

3. A method according to claim 1 , wherein said code tag is of the type quick response (QR), 2D code, barcode, RFID or NFC code/tag, or a character code visible to the naked eye.

4. A method according to claim 1, wherein said reading is accomplished by a scanner or a camera comprised in said cellular device.

5. A method according to claim 1, wherein the card is a pseudo card provisioned as software in the POS terminal.

6. A system adapted to the payment of goods through a retailer point of sale terminal site utilizing a cellular device to close a purchase at the retailer, said terminal comprising at least one card reader slot, wherein:
a back end network connected to said terminal at its site, a terminal card, having a unique card code belonging to said terminal and retailer, where the card code issuer (PSP) provides the card with its unique issuer code differing from current issuer card codes, said terminal being utilized by the terminal operating clerk to enable a reading of the terminal card data when a customer is closing a purchase;
a telecommunication switch, which recognizes said unique issuer code, and sends said card data to;
a payment settlement switch through said existing terminal back end network when utilized by said clerk to identify the retailer and the unique terminal transmitting said card data;
a payment application stored in said cellular device adapted to read a tag at said terminal site through reading means attached to said cellular device, and to trigger a communication to said settlement switch;
a terminal code tag placed at said terminal site, which is unique to the terminal and matching at least a part of the code of the terminal card, to be read by a customer utilizing said cellular device to register said code in the cellular device through said reading means, said cellular device upon agreement by the customer, through the cellular device, transmitting the read unique terminal code through a cellular network related to the cellular device, to said settlement switch when closing a purchase; and
a matching means adapted to match the unique card code with said terminal code, and closing the purchase when there is at least partly a match between the two codes transmitted, by sending a clearance note to said point of sale terminal through said back end network, thus enabling a utilization of an existing point of sale; said switch settling the purchase with accounts belonging to the retailer and customer, respectively.

7. A system according to claim 6, wherein a payment settlement switch transmits all details about a purchase to a customer's cellular device as a receipt, initiated by said switch to a customer's cellular device.

8. A system according to claim 6, wherein said code tag is of the type quick response (QR), 2D code, barcode, RFID code, or a character code visible to the naked eye.

9. A system according to claim 6, wherein said reading means is a scanner or a camera comprised in said cellular device.

10. A system according to claim 6, wherein the card is a pseudo card provisioned as software in the POS terminal.
